(19) United States
(12) Patent Application Publication
(10) Pub. No.: US 2022/0289122 A1
(43) Pub. Date: Sep. 15, 2022

(54) Trailer Hitch Storage Apparatus

(71) Applicant: Steven Ladosz, Tilsonburg (CA)

(72) Inventor: Steven Ladosz, Tilsonburg (CA)

(21) Appl. No.: 17/200,964

(22) Filed: Mar. 15, 2021

(51) Int. Cl. B60R 11/06

(52) U.S. Cl. CPC B60R 11/06; B60R 2011/0024

(57) ABSTRACT

An apparatus for storing and organizing trailer hitch accessories; the apparatus includes a mounting plate, at least one shelf, a set of support shafts and at least one set of mount-accessory holders. The apparatus is particularly useful for storing and organizing hitch ball mount assemblies used with receiver-type hitches. The apparatus preferably stores and organizes hitch ball mounts, hitch balls, and hitch pins.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### TECHNICAL FIELD

The present invention relates generally to the field of vehicle accessories of existing art and more specifically relates to an apparatus for storing trailer hitch accessories.

### RELATED ART

A trailer hitch is an apparatus that attaches to a vehicle and permits towing of a trailer. A common type of trailer hitch is a receiver-type hitch which consists of an assembly that mounts to the vehicle and accepts, or “receives” hitch accessories, particularly hitch ball mount assemblies. Hitch ball mount assemblies include a ball mount that has an end for connecting to the receiver, and an opposite end for attaching a hitch ball thereto. The trailer then attaches to the hitch ball to connect it to the vehicle for towing.

There are a variety of classes of trailer hitches, from Class 1 for light loads, up to Class 5 for large loads. As such, an individual may own a variety of different trailer hitches and accessories therefor. A problem with this is that there is currently no satisfactory means of storing and organizing these trailer hitches and accessories. As such, they are often left scattered about a garage floor, which can cause unnecessary time spent finding a specific hitch/accessory, can become a safety hazard, and simply, looks messy. Thus, a suitable solution is desired.

### SUMMARY OF THE INVENTION

In view of the foregoing disadvantages inherent in the known vehicle accessory art, the present disclosure provides a novel trailer hitch storage apparatus. The general purpose of the present disclosure, which will be described subsequently in greater detail, is to provide a means of easily storing and organizing trailer hitches and accessories therefor.

An apparatus is disclosed herein. The apparatus includes a mounting plate configured to mount the apparatus to a wall surface. The mounting plate may be defined by a top-side opposite a bottom-side and a left-side opposite a right-side and relative to the wall surface. At least one shelf may be attached to the mounting plate. The at least one shelf may include a shelf-surface having a horizontal-length relative to the left-side and the right-side of the mounting plate. A set of support shafts may be attached along the horizontal-length of the shelf-surface and extend upwardly therefrom. Each support shaft may include a body having a vertical-length and may be configured to receive and hold a hitch ball-mount. At least one set of mount-accessory holders may be attached about the mounting plate. Each of the mount-accessory holders may be configured to receive and hold at least one of a hitch-pin and a hitch-ball.

According to another embodiment, a method of using an apparatus for storing and organizing trailer hitch accessories is also disclosed herein. The method includes providing the apparatus as above; mounting the apparatus to the wall surface via the mounting plate; attaching to the apparatus at least one hitch ball-mount, whereby the at least one hitch ball-mount is slidably-received by one of said support shafts; and attaching to the apparatus at least one of at least one hitch-pin and/or at least one hitch-ball, whereby the at least one hitch-pin is slidably inserted in one of the mount-accessory holders and whereby the at least one hitch-ball is slidably inserted in the one of the mount-accessory holders.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a trailer hitch storage apparatus, constructed and operative according to the teachings of the present disclosure.

FIG. 1 is a front perspective view of the apparatus during an ‘in-use’ condition, according to an embodiment of the disclosure.

FIG. 2 is a front view of the apparatus of FIG. 1 illustrating the apparatus with accessories detached therefrom, according to an embodiment of the present disclosure.

FIG. 3 is a side view of the apparatus of FIG. 1, according to an embodiment of the present disclosure.

FIG. 4 is a front side perspective view of the apparatus of FIG. 1, illustrating a hitch ball-mount relative to a support shaft from a set of support shafts, according to an embodiment of the present disclosure.

FIG. 5 is a side perspective view of the apparatus of FIG. 1, according to another embodiment of the present disclosure.

FIG. 6 is a flow diagram illustrating a method of using an apparatus for storing and organizing trailer hitch accessories, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to vehicle accessories and more particularly to a trailer hitcher storage apparatus as used to improve storage and organization of trailer hitches and accessories therefor.

Generally disclosed is a device including a flat piece of metal with angled square tubes attached thereto. Hitches may then be slid into the square tubes vertically so that they are not sticking out far from a wall surface. Located underneath the square tubes may be a small metal shelf with holes therein to hold and hang balls for hitches. Underneath this small metal shelf may be a second small metal shelf. Holders may be located about the flat piece of metal which may slidably receive hitch pins therethrough. The device may be useful for holding hitch pins, hitch balls, and multiple different hitches.

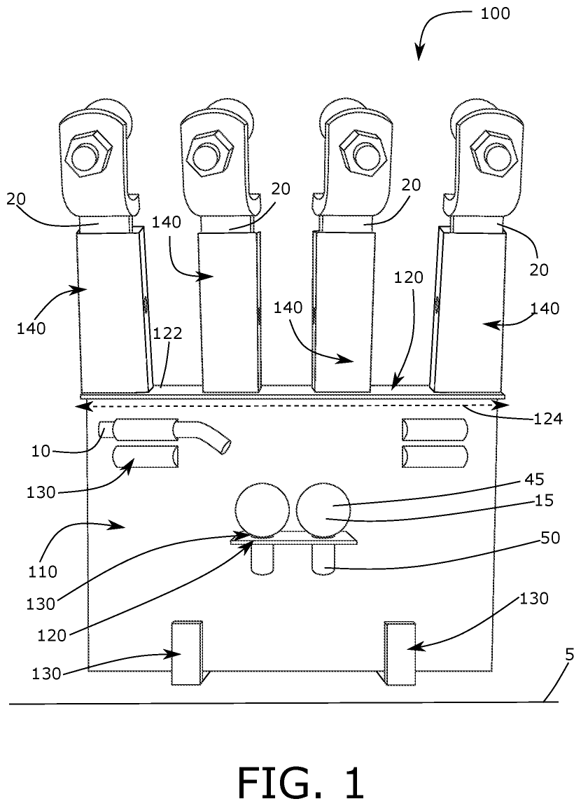

Referring now more specifically to the drawings by numerals of reference, there is shown in FIGS. 1-5, various views of an apparatus 100.

As discussed above, the apparatus 100 may be used for storing and organizing trailer hitch accessories. As shown in FIG. 1, the apparatus 100 may include a mounting plate 110, at least one shelf 120, at least one set of mount-accessory holders 130, and a set of support shafts 140. The apparatus 100 may be used for storing and organizing trailer hitch accessories. Particularly, the trailer hitch accessories may include one or more ball mount assemblies used with receiver-type hitches, and one or more hitch pins. In some embodiments, the apparatus 100 may comprise a metal material. This may provide strength and rigidity to the apparatus 100 to enable the apparatus 100 to hold heavy trailer hitch accessories. Other materials are also contemplated.

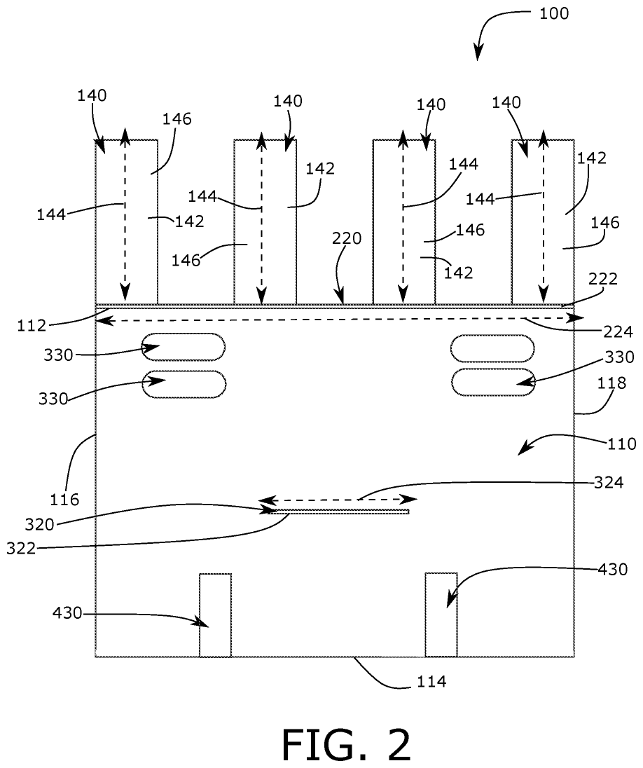

The mounting plate 110 may be configured to mount the apparatus 100 to a wall surface 5 (FIG. 1) and as shown in FIG. 2, may be defined by a top-side 112 opposite a bottom-side 114 and a left-side 116 opposite a right-side 118, relative to the wall surface 5. The mounting plate 110 may include a height of 10¾ inches. Preferably, the wall surface 5 may be a garage wall, an automobile body shop wall, or the like so that a user is able to store the trailer hitch accessories where they are readily accessible for use. Further, the mounting plate 110 may be flush to the wall surface 5 when mounted thereto, so as to prevent the apparatus 100, and the trailer hitch accessories mounted thereto, from being obtrusive or obstructive. This may be particularly useful for smaller garages or other smaller spaces.

In some embodiments, the mounting plate 110 may attach to the wall surface 5 via screws (not illustrated). This may aid in mounting the apparatus 100 flush to the wall surface 5. However, other mounting means are also contemplated. For example, the mounting plate 110 may include mounting means that do not cause damage to the wall surface 5, such as adhesive strips.

As shown in FIG. 1, the at least one shelf 120 may be attached to the mounting plate 110. The at least one shelf 120 may include a shelf-surface 122 having a horizontal-length 124 spanning the left-side 116 and the right-side 118 of the mounting plate 110. As shown, the set of support shafts 140 may be attached along the horizontal-length 124 of the shelf-surface 122 and may extend upwardly therefrom. Preferably, the set of support shafts 140 may be fixedly attached to the apparatus 100. For example, the set of support shafts 140 may be welded to the shelf-surface 122.

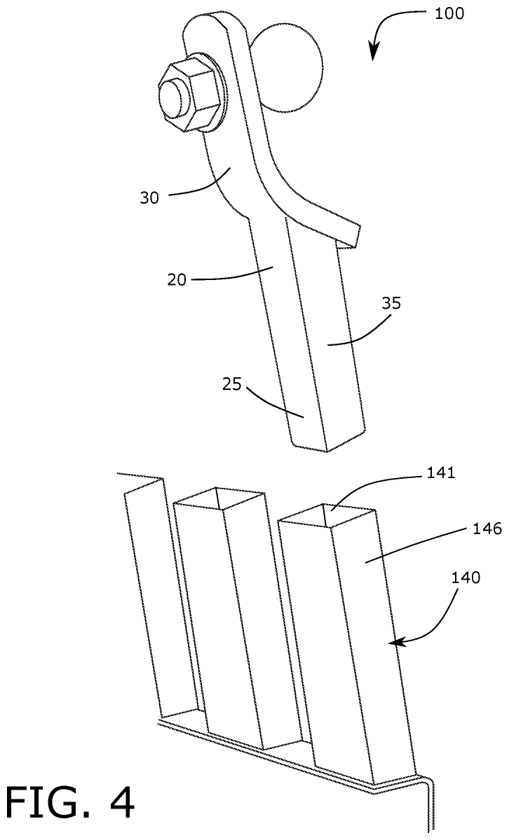

As shown in FIG. 1, each support shaft 146 may be configured to receive and hold a hitch ball-mount 20. As illustrated specifically in FIG. 4, the hitch ball-mount 20 may be any standard hitch ball-mount including a receiver connector-end 25 configured for insertion into the receiver-type hitch as discussed above; a ball mount-end 30 configured for receiving a hitch-ball 15 (to which a trailer is attached); and an elongated-tube 35 therebetween. The apparatus 100 may be configured to support more than one hitch ball-mount 20. For example, as shown in FIG. 1, the apparatus 100 may be configured support four hitch ball-mounts 20. Each support shaft 146 may be spaced apart sufficiently so as to allow space for differently sized hitch ball-mounts 20. For example, each support shaft 146 may be spaced 2 inches apart. It is contemplated that each support shaft 146 may be configured to hold hitch ball-mounts 20 for hitch sizes between 1¼ inch-3 inches and including a variety of rise heights.

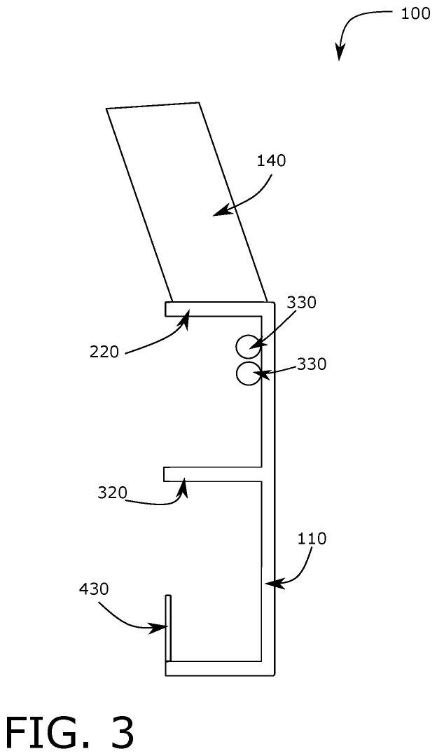

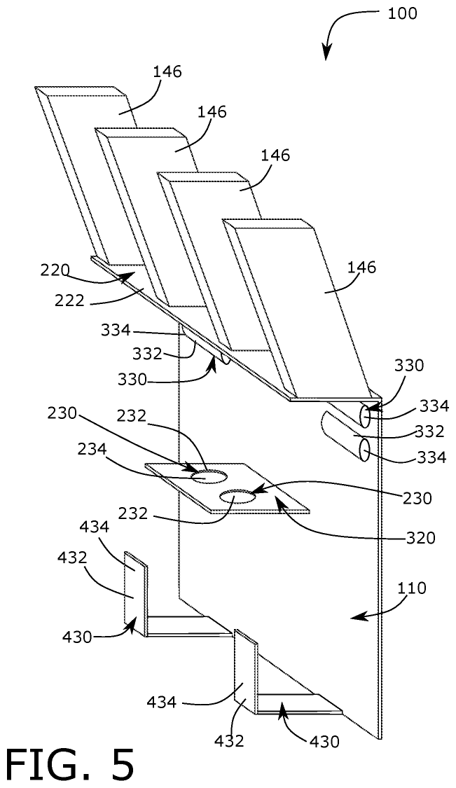

As FIG. 2 illustrates, each support shaft 146 may include a body 142 having a vertical-length 144. In some embodiments, one or more of the support shafts 146 may include a vertical-length 144 that is angled at less than 90 degrees relative to the horizontal-length 124 (illustrated specifically in FIG. 3 and FIG. 5). In other embodiments, the vertical-length 144 may be substantially perpendicular to the horizontal-length 124. Further, as above, the hitch ball-mount 20 may include the receiver connector-end 25, the ball mount-end 30 and the elongated-tube 35 therebetween.

In some embodiments, as demonstrated in FIG. 1 and FIG. 4, each support shaft 146 may include a hollow interior 141. In this embodiment, each support shaft 146 (the hollow interior 141 thereof) may be configured to receive the elongated-tube 35 therein (receiver connector-end 25 first). To aid in this, each support shaft 146 may be larger than the general size of the hitch ball-mount 20 to accommodate the hitch ball-mount 20. Further, each support shaft 146 may include a shape similar to a general shape of the hitch-ball mount 20. For example, each support shaft 146 may include a rectangular cuboid shape 143. However, it should be appreciated that any accommodating shape is contemplated for each support shaft 146.

It should also be appreciated that the apparatus 100 is not limited to this means of connection. For example, the elongated-tube 35 may be hollow and in some embodiments, each hitch-ball mount 20 may be attached to the apparatus 100 by sliding the elongated-tube 35 over a selected support shaft 146 (receiver connector-end 25 first). To aid in this connection, each support shaft 146 may be smaller than a general size of the hitch ball-mount 20.

As shown in FIG. 1, the at least one set of mount-accessory holders 130 may be attached about the mounting plate 110 and each mount-accessory holder 132 thereof may be configured to receive and hold at least one of a hitch-pin 10 and/or a hitch-ball 15. For example, in some embodiments each of the mount-accessory holders 132 may only be sized to receive hitch-pins 10; in other embodiments, each of the mount-accessory holders 132 may only be sized to receive hitch-balls 15; and in other embodiments, each of the mount-accessory holders 132 may be sized to receive both hitch-pins 10 and hitch-balls 15. In the embodiment whereby the mount-accessory holders 132 are only sized to receive hitch-pins 10, the hitch-balls 15 may be fastened to the ball mount-end 30 of the hitch ball-mount 20 and therefore still stored and organized on the apparatus 100.

Preferably, as shown in FIG. 2 and FIG. 5, at least one set of mount-accessory holders 130 may include a first set of mount-accessory holders 230 including a plurality of first mount-accessory-holders 232, and a second set of mount-accessory holders 330 including a plurality of second mount-accessory-holders 332. Each first mount-accessory-holder 232 from the first set of mount-accessory holders 230 may include an aperture 234 (FIG. 5) sized and configured to receive and hold one hitch-ball 15 (FIG. 1). As shown in FIG. 1, preferably, the apparatus 100 may be configured to hold at least two hitch-balls 15. The hitch-ball 15 may include a ball end 45 opposite a threaded end (shank) 50, the threaded end 50 being configured for insertion into the ball mount-end 30 of the hitch ball-mount 20. The user may insert the threaded end 50 of the hitch-ball 15 into a selected first mount-accessory-holder 232.

It is contemplated that the first set of mount-accessory holders 230 may each be sized to hold a variety of sizes of hitch-balls 15. For example, 1⅞-inch hitch-balls, 2-inch hitch-balls, 2 5/16-inch hitch-balls, 3-inch hitch-balls, etc. Particularly, the first mount-accessory-holders 232 may be configured to hold hitch-balls 15 with the threaded ends (shanks) 50 thereof including a diameter of between ¾-inches-2 inches. In some embodiments, the first mount-accessory-holders 232 may include varying diameter sizes, or in other embodiments, the first mount-accessory-holders 232 may each include a standard diameter to accommodate hitch-balls 15 of varying sizes. For example, each first mount-accessory-holder 232 may be 2 inches in diameter to accommodate threaded ends 50 including a diameter of between ¾-inches-2 inches.

As shown in FIG. 5, the second mount-accessory-holder 332 from the second set of mount-accessory holders 330 may include a receptacle 334. The receptacle 334 may be sized and configured to receive and hold one hitch-pin 10, as shown in FIG. 1. In some embodiments, the receptacle 334 may be a cylindrical metal tube. Preferably, the apparatus 100 may be configured to hold a plurality of hitch-pins 10. The hitch-pins 10 may include a bent profile, and as such, the bent profile may hold the hitch-pin 10 in the mount-accessory holder 132/second mount-accessory-holder 332, (and prevent the hitch-pin 10 from falling out of the mount-accessory holder 132/second mount-accessory-holder 332). It is contemplated that second set of mount-accessory holders 330 may each be sized to hold a variety of sized hitch-pins 10. For example, the second mount-accessory-holder 332 may be configured to hold a hitch-pin 10 including a ½-inch diameter, a hitch-pin 10 including a ⅝-inch diameter, and the like.

Further, as shown in FIGS. 1-3 and FIG. 5, the at least one set of mount-accessory holders 130 may include a third set of mount-accessory holders 430 including a plurality of third mount-accessory-holders 432. The third set of mount-accessory holders 430 may be attached to the bottom-side 114 of the mounting plate 110. Each third mount-accessory-holder 432 from the third set of mount-accessory holders 430 may include a hook 434 (FIG. 5). It is contemplated that the hook 434 may be configured for holding a variety of accessories and items, which may not be limited to mount-accessories, or hitch accessories. Each third mount-accessory-holder 432 may include a height of 2 inches.

Further, in some embodiments, as shown in FIGS. 2-3 and FIG. 5, the at least one shelf 120 may include a first shelf 220, and a second shelf 320. The first shelf 220 may include a first shelf-surface 222 having a first horizontal-length 224 and the second shelf 320 may include a second shelf-surface 322 having a second horizontal-length 324. As shown, the first shelf 220 may be attached to the top-side 112 of the mounting plate 110. In this embodiment, the set of support shafts 140 may be attached along the first horizontal-length 224 of the first shelf-surface 222. Further, the second shelf 320 may be attached about a mid-section 119 of the mounting plate 110. In this embodiment, the first set of mount-accessory holders 230 may be located within the second shelf 320, the second set of mount-accessory holders 330 may be attached to the mounting plate 110. Each shelf (220, 320) may include a depth of 2¾ inches.

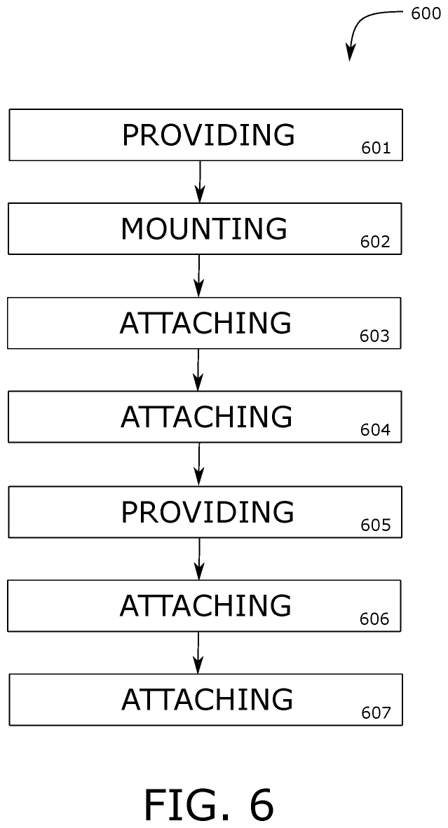

Referring now to FIG. 6 showing a flow diagram illustrating a method 600 of using an apparatus for storing and organizing trailer hitch accessories, according to an embodiment of the present disclosure. In particular, the method 600 may include one or more components or features of the apparatus 100 as described above. As illustrated, the method of use 600 may include the steps of: step one 601, providing the apparatus; step two 602, mounting the apparatus to the wall surface via the mounting plate; step three 603, attaching to the apparatus at least one hitch ball-mount, whereby the at least one hitch ball-mount is slidably-received by one of said support shafts; and step four 604, attaching to the apparatus at least one of at least one hitch-pin and/or at least one hitch-ball, whereby the at least one hitch-pin is slidably inserted in one of said mount-accessory holders and whereby the at least one hitch-ball is slidably inserted in said one of the mount-accessory holders.

Further steps may include step five 605, providing the apparatus wherein the at least one set of mount-accessory holders includes the first set of mount-accessory holders including the plurality of first-mount-accessory holders, and the second set of mount-accessory holders including the plurality of second-mount-accessory holders; step six 606, attaching the at least one hitch-ball to the apparatus, whereby the at least one hitch-ball is slidably inserted into one of said first mount-accessory-holders; and step seven 607, attaching the at least one hitch-pin to the apparatus, whereby the at least one hitch-pin is slidably inserted into one of said second-mount-accessory-holders.

It should be noted that step five 605, step six 606, and step seven 607 are optional steps and may not be implemented in all cases. Optional steps of method 600 are illustrated using dotted lines in FIG. 6 so as to distinguish them from the other steps of method 600. It should also be noted that the steps described in the method of use can be carried out in many different orders according to user preference. The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for storing and organizing trailer hitch accessories are taught herein. Those with ordinary skill in the art will now appreciate that upon reading this specification and by their understanding the art of trailer hitches and accessories as described herein, methods of using, storing and organizing the trailer hitches and accessories will be understood by those knowledgeable in such art.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An apparatus for storing and organizing trailer hitch accessories, the apparatus comprising:
a mounting plate configured to mount the apparatus to a wall surface, the mounting plate defined by a top-side opposite a bottom-side and a left-side opposite a right-side and relative to the wall surface;
at least one shelf attached to the mounting plate, the at least one shelf including a shelf-surface having a horizontal-length relative to the left-side and the right-side of the mounting plate;
a set of support shafts attached along the horizontal-length of the shelf-surface and extending upwardly therefrom, each support shaft including a body having a vertical-length, each support shaft being configured to receive and hold a hitch ball-mount; and
at least one set of mount-accessory holders attached about the mounting plate, each said mount-accessory holder configured to receive and hold at least one of a hitch-pin and a hitch-ball.

2. The apparatus of claim 1, wherein each said support shaft includes a hollow interior, wherein the hitch ball-mount includes a receiver connector-end, a ball mount-end, and an elongated-tube therebetween, and wherein the hollow interior is configured to receive the elongated-tube therein.

3. The apparatus of claim 2, wherein each said support shaft includes a rectangular cuboid shape.

4. The apparatus of claim 3, wherein the set of support shafts are fixedly attached to the apparatus.

5. The apparatus of claim 1, wherein the at least one set of mount-accessory holders includes a first set of mount-accessory holders including a plurality of first mount-accessory-holders, and a second set of mount-accessory holders including a plurality of second mount-accessory-holders.

6. The apparatus of claim 5, wherein the at least one set of mount-accessory holders includes the first set of mount-accessory holders including the plurality of first mount-accessory-holders, the second set of mount-accessory holders including the plurality of second mount-accessory-holders, and a third set of mount-accessory holders including a plurality of third mount-accessory-holders.

7. The apparatus of claim 6, wherein each said first mount-accessory-holder from the first set of mount-accessory holders includes an aperture sized and configured to receive and hold one hitch-ball.

8. The apparatus of claim 7, wherein each second mount-accessory-holder from the second set of mount-accessory holders includes a receptacle sized and configured to receive and hold one hitch-pin.

9. The apparatus of claim 8, wherein each third mount-accessory-holder from the third set of mount-accessory holders includes a hook.

10. The apparatus of claim 1, wherein the at least one shelf includes a first shelf, and a second shelf, the first shelf including a first shelf-surface having a first horizontal-length, and the second shelf including a second shelf-surface having a second horizontal-length.

11. The apparatus of claim 10, wherein the first shelf is attached to the top-side of the mounting plate, and wherein the second shelf is attached to about a mid-section of the mounting plate.

12. The apparatus of claim 11, wherein the first set of mount-accessory holders are located within the second shelf.

13. The apparatus of claim 12, wherein the second set of mount-accessory holders are attached to the mounting plate.

14. The apparatus of claim 13, wherein the third set of mount-accessory holders are attached to the bottom-side of the mounting plate.

15. The apparatus of claim 1, wherein the mounting plate is flush to the wall surface.

16. An apparatus for storing and organizing trailer hitch accessories, the apparatus comprising:
a mounting plate configured to mount the apparatus flush to a wall surface, the mounting plate defined by a top-side opposite a bottom-side and a left-side opposite a right-side and relative to the wall surface;
a first shelf attached to the top-side of the mounting plate, the first shelf including a first shelf-surface having a first horizontal-length relative to the left-side and the right-side of the mounting plate;
a set of support shafts attached along the first horizontal-length of the first shelf-surface and extending upwardly therefrom, each support shaft including a body having a vertical-length, each support shaft being configured to receive and hold a hitch ball-mount, each said support shaft further including a hollow interior, the hitch ball-mount including a receiver connector-end, a ball mount-end, and an elongated-tube therebetween, and wherein the hollow interior is configured to receive the elongated-tube therein;
a second shelf attached about a mid-section of the mounting plate, the second shelf including a second shelf-surface having a second horizontal-length relative to the left-side and the right-side of the mounting plate;
a first set of mount-accessory holders located within the second shelf, the first set of mount-accessory holders including a plurality of first mount-accessory-holders, each said first mount-accessory-holder including an aperture sized and configured to receive and hold one hitch-ball;
a second set of mount-accessory holders attached to the mounting plate, the second set of mount-accessory holders including a plurality of second mount-accessory-holders, each said second mount-accessory-holder including a receptacle sized and configured to receive and hold one hitch-pin; and
a third set of mount-accessory holders attached to the bottom-side of the mounting plate, the third set of mount-accessory holders including a plurality of third mount-accessory-holders, each said third mount-accessory-holder including a hook.

17. The apparatus of claim 16, wherein each said support shaft includes a rectangular cuboid shape.

18. The apparatus of claim 17, wherein the set of support shafts are fixedly attached to the apparatus.

19. A method of using an apparatus for storing and organizing trailer hitch accessories, the method comprising the steps of:
providing the apparatus including:
a mounting plate configured to mount the apparatus to a wall surface, the mounting plate defined by a top-side opposite a bottom-side and a left-side opposite a right-side and relative to the wall surface;
at least one shelf attached to the mounting plate, the at least one shelf including a shelf-surface having a horizontal-length relative to the left-side and the right-side of the mounting plate;
a set of support shafts attached along the horizontal-length of the shelf-surface and extending upwardly therefrom, each support shaft including a body having a vertical-length, each support shaft being configured to receive and hold a hitch ball-mount; and
at least one set of mount-accessory holders attached about the mounting plate, said mount-accessory holder configured to receive and hold at least one of a hitch-pin and a hitch-ball.
mounting the apparatus to the wall surface via the mounting plate;
attaching to the apparatus at least one hitch ball-mount, whereby the at least one hitch ball-mount is slidably-received by one of said support shafts; and
attaching to the apparatus at least one of:
at least one hitch-pin, whereby the at least one hitch-pin is slidably inserted in one of said mount-accessory holders; and
and at least one hitch-ball, whereby the at least one hitch-ball is slidably inserted in said one of said mount-accessory holders.

20. The method of claim 19, further comprising the steps of:
providing the apparatus wherein the at least one set of mount-accessory holders includes a first set of mount-accessory holders including a plurality of first-mount-accessory holders, and a second set of mount-accessory holders including a plurality of second-mount-accessory holders;
attaching to the apparatus the at least one hitch-ball, whereby the at least one hitch-ball is slidably inserted into one of said first-mount-accessory holders; and
attaching to the apparatus the at least one hitch-pin, whereby the at least one hitch-pin is slidably inserted into one of said second-mount-accessory holders.
